(19) United States
(12) Patent Application Publication
(10) Pub. No.: US 2026/0299359 A1
(43) Pub. Date: Oct. 1, 2026

(54) CREATING RADIAL REFRACTIVE INDEX PATTERNS IN LIQUID CRYSTAL MATERIAL

(71) Applicant: Flexenable Technology Limited, Cambridge (GB)

(72) Inventors: James Bailey, Ely (GB); May Wheeler, Cambridge (GB); James Harding, Cambridge (GB)

(21) Appl. No.: 19/478,171

(22) PCT Filed: Apr. 26, 2024
(86) PCT No.: PCT/EP2024/061566

§ 371 Date: Oct. 23, 2025

(30) Foreign Application Priority Data
Apr. 27, 2023 (GB) 2306260.7

(51) Int. Cl. G02F 1/1343; G02B 3/08; G02B 3/14; G02C 7/08; G02F 1/1335; G02F 1/1345

(52) U.S. Cl. CPC G02F 1/13439; G02B 3/08; G02B 3/14; G02C 7/083; G02F 1/133526; G02F 1/13452

(57) ABSTRACT

A liquid crystal device comprising at least one liquid crystal cell, the liquid crystal cell comprising first and second half-cells and liquid crystal material contained between the first and second half-cells; the first and/or second half-cells comprising a first electrode pattern for creating a first radial refractive index pattern in a first region of the liquid crystal material, and a second electrode pattern for creating a second radial refractive index pattern at least partly in the first region of the liquid crystal material; and the liquid crystal device being switchable between activating the first electrode pattern and activating the second electrode pattern.

The present application relates to creating radial refractive index patterns in liquid crystal material. Radial refractive index patterns in liquid crystal material may, for example, be used to manipulate electromagnetic radiation, such as visible light. For example, a radial refractive index pattern in a liquid crystal material may function as a positive or negative lens in a wide range of optical devices.

One technique for creating radial refractive index patterns in a region of liquid crystal material uses a liquid crystal cell comprising a radial electrode pattern on one side of the region of the liquid crystal material, and an unpatterned, blanket electrode on the opposite side of the region of the liquid crystal material. In a known example of a radial electrode pattern a stack of such liquid crystal cells may provide a stack of co-operatively aligned refractive index patterns in respective volumes of liquid crystal material, which together can co-operatively provide an increased optical power.

The inventor for the present application has worked on developing a new technique for creating radial refractive index patterns in liquid crystal material.

A liquid crystal device comprising at least one liquid crystal cell, wherein the liquid crystal cell comprises first and second half-cells and liquid crystal material contained between the first and second half-cells; wherein the first and/or second half-cells comprise a first electrode pattern for creating a first radial refractive index pattern in a first region of the liquid crystal material, and a second electrode pattern for creating a second radial refractive index pattern at least partly in the first region of the liquid crystal material; and wherein the liquid crystal device is switchable between activating the first electrode pattern and activating the second electrode pattern.

The first half-cell may comprise the first electrode pattern and the second half-cell may comprise the second electrode pattern.

The first and second electrode patterns may be centered on a common axis.

The first electrode pattern may comprise a first set of concentric rings and the second electrode pattern may comprise a second set of concentric rings.

The first electrode pattern may comprise a first set of links connecting the first set of concentric rings and the second electrode pattern may comprise a second set of links connecting the second set of concentric rings.

A first link of the first set of links may have a larger resistance than a second link of the first set of links radially outward of the first link of the first set of links and a first link of the second set of links may have a smaller resistance than a second link of the second set of links radially outward of the third link of the second set of links.

The first set of concentric rings may correspond to the second set of concentric rings in at least one of: an area of each ring, a radius of each ring, a depth of each ring, a material of each ring, a spacing between each pair of adjacent rings, or a number of rings.

The first set of concentric rings may be substantially aligned with the second set of concentric rings in a direction parallel to a common axis.

The first and second electrode patterns may have different radial resistance profiles.

The first electrode pattern may comprise a plurality of first concentric sections, wherein each first concentric section may comprise a first set of concentric rings and a first set of links connecting the first set of concentric rings; and the second electrode pattern may comprise a plurality of second concentric sections, wherein each second concentric section may comprise a second set of concentric rings and a second set of links connecting the second set of concentric rings; wherein each first set of links may sequentially increase in resistance radially inwards, and each second set of links may sequentially decrease in resistance radially inwards.

The first concentric sections may comprise at least one first concentric section having a radially innermost link exhibiting a higher electrical resistance than a radially outermost link of another, radially inwardly adjacent first concentric section; and the second concentric sections may comprise at least one second concentric section having a radially innermost link exhibiting a lower electrical resistance than a radially outermost link of another, radially inwardly adjacent second concentric section.

The first half-cell may comprise at least one support film, and the first electrode pattern may be located between an innermost support film of the first half-cell and the liquid crystal material; and the second half-cell may comprise at least one support film, and the first electrode pattern may be located between an innermost support film of the second half-cell and the liquid crystal material.

The liquid crystal device may be switchable between (i) applying a potential difference across terminals of the first electrode pattern while keeping the terminals of the second electrode pattern at a common potential, and (ii) applying the potential difference across terminals of the second electrode pattern while keeping the terminals of the first electrode pattern at a common potential.

The liquid crystal device may be operable as an adaptive optical lens.

The liquid crystal device may be operable as an optical lens switchable between: a positive focal power with the first electrode pattern activated, and a negative focal power with the second electrode pattern activated.

An assembly comprising: a liquid crystal cell comprising: first and second half-cells and liquid crystal material contained between the first and second half-cells; the first and/or second half-cells comprising a first electrode pattern for creating a first radial refractive index pattern in a first region of the liquid crystal material, and a second electrode pattern for creating a second radial refractive index pattern at least partly in the first region of the liquid crystal material; the liquid crystal device being switchable between activating the first electrode pattern and activating the second electrode pattern; and at least one further optical element.

The at least one further optical element may comprise at least one of: a waveguide, a luminance adjustment component, a lens, an image generation device, a reflection-reduction layer, or a protective layer.

Apparatus comprising: a liquid crystal cell comprising first and second half-cells and liquid crystal material contained between the first and second half-cells, the first and/or second half-cells comprising a first electrode pattern for creating a first radial refractive index pattern in a first region of the liquid crystal material, and a second electrode pattern for creating a second radial refractive index pattern at least partly in the first region of the liquid crystal material; at least one processor; and at least one storage comprising instructions, the instructions configured to, with the at least one processor, cause the apparatus to switch between: activation of the first electrode pattern; and activation of the second electrode pattern.

The apparatus may comprise at least one electrical connection connected to the first electrode pattern and the second electrode pattern; and driving circuitry connected to the at least one electrical connection to apply a potential difference between at least part of the first electrode pattern and at least part of the second electrode pattern.

The apparatus may comprise at least one sensor to obtain eye tracking data, the instructions configured to, with the at least one processor, cause the apparatus to switch between the activation of the first electrode pattern and the activation of the second electrode pattern at least partly based on the eye tracking data.

The apparatus may be configured to be mounted on a human head with the liquid crystal cell positioned in a field of view of an eye of the human head.

The apparatus may comprise a first lens comprising a first one of the liquid crystal cell; and a second lens comprising a second one of the liquid crystal cell.

The instructions may be configured to, with the at least one processor, cause the apparatus to switch the first lens to a first focal power and the second lens to a second focal power different from the first focal power.

The first focal power may be a positive focal power and the second focal power may be a negative focal power.

The field of view of the eye may be a first field of view of a first eye, and the first lens may be configured to be positioned in the first field of view, in use, and the second lens may be configured to be positioned in a second field of view of a second eye of the human head, in use.

The apparatus may be at least one of: an augmented reality display device, a virtual reality display device or a mixed reality display device.

A method of operating a liquid crystal device comprising at least one liquid crystal cell, the liquid crystal cell comprising first and second half-cells and liquid crystal material contained between the first and second half-cells; the first and/or second half-cells comprising a first electrode pattern for creating a first radial refractive index pattern in a first region of the liquid crystal material, and a second electrode pattern for creating a second radial refractive index pattern at least partly in the first region of the liquid crystal material; the method comprising switching between (i) applying a potential difference across electrical terminals connected to the first electrode pattern and (ii) applying a potential difference across electric terminals connected to the second electrode pattern.

Examples are hereunder described in detail, by way of example only, with reference to the accompanying drawings, in which:

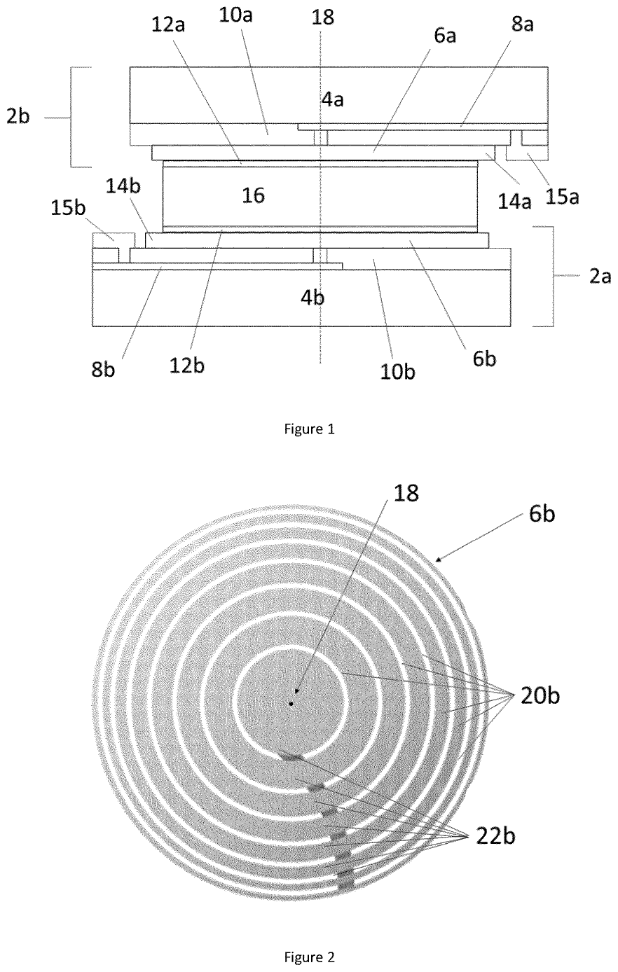

FIG. 1 shows a representation of a device according to examples;

FIG. 2 shows a representation of a radial electrode pattern for one half-cell of the device of FIG. 1 according to examples;

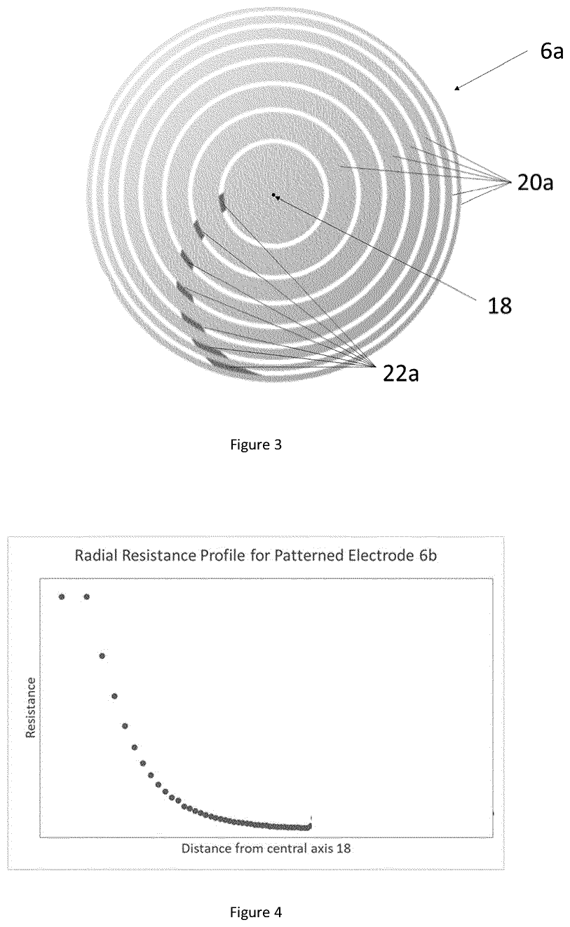

FIG. 3 shows a representation of a radial electrode pattern for the other half-cell of the device of FIG. 1 according to examples;

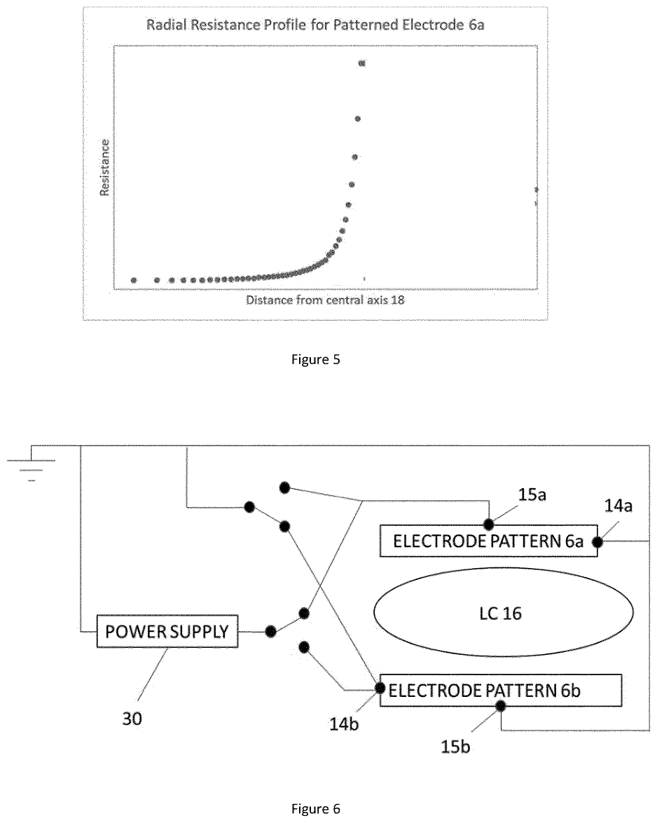

FIGS. 4 and 5 show representations of a pair of radial resistance profiles for the radial electrode patterns of the device of FIG. 1 according to examples;

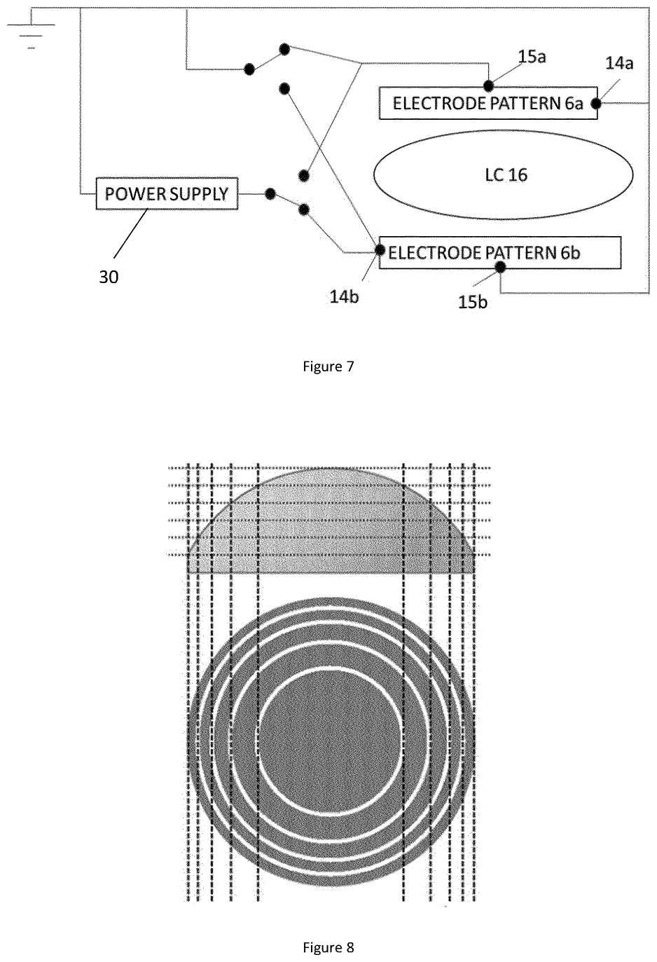

FIGS. 6 and 7 show a representation of circuitry for switching the output of a power supply from across the terminals of one of the radial electrode patterns of the device of FIG. 1 to across the terminals of the other of the two radial electrode patterns of the device of FIG. 1 according to examples;

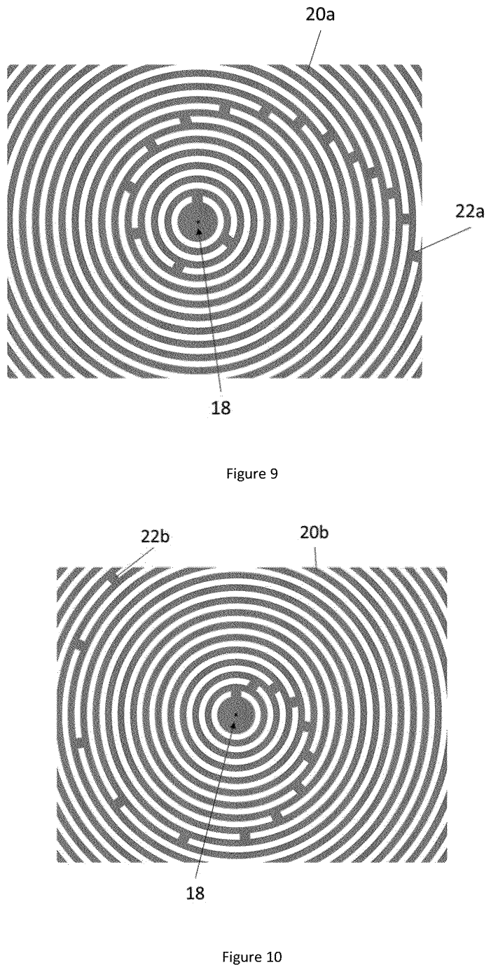

FIG. 8 illustrates a refractive index (RI) pattern and a corresponding electrode pattern comprising an array of concentric rings according to examples;

FIGS. 9 and 10 illustrate a pair of radial electrode patterns for the device of FIG. 1 according to further examples;

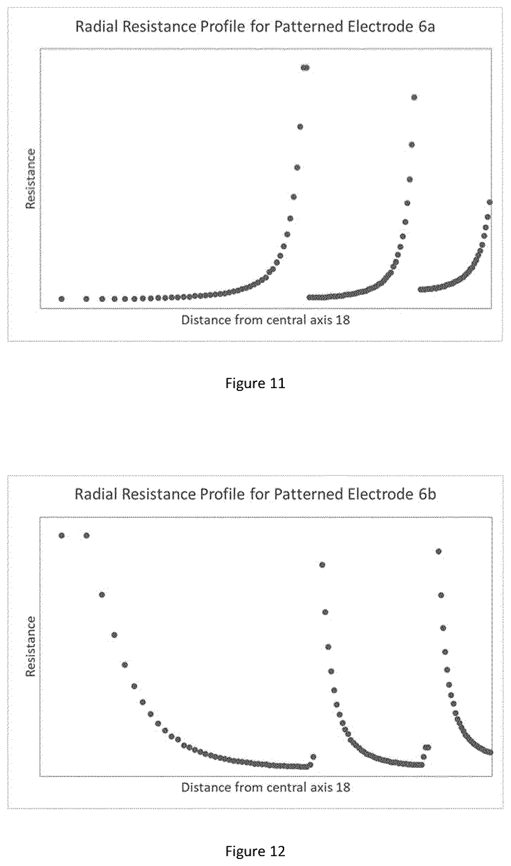

FIGS. 11 and 12 illustrate a pair of radial resistance profiles for the radial electrode patterns of the device of FIG. 1 according to yet further examples;

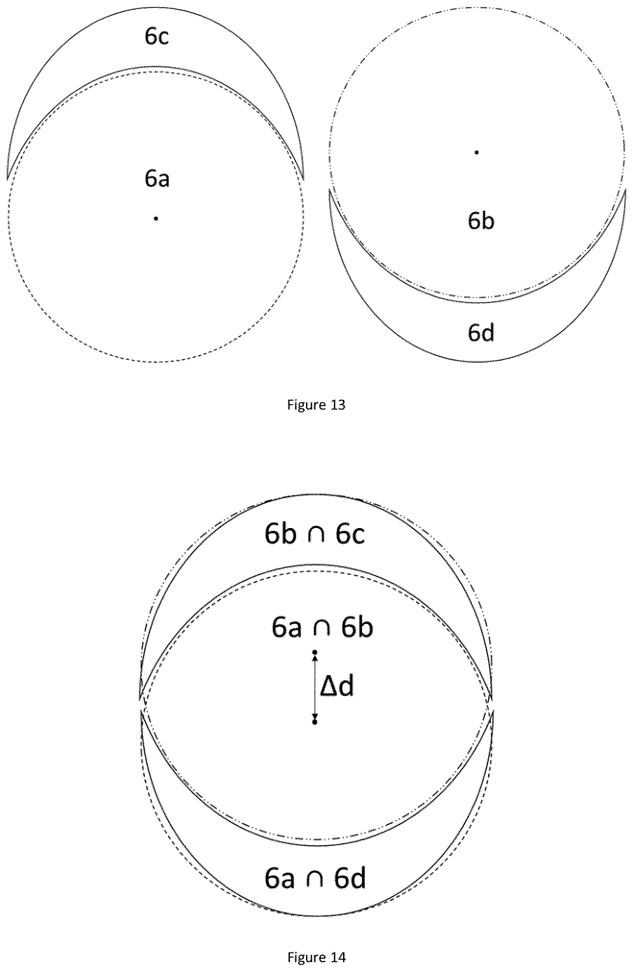

FIGS. 13 and 14 illustrate an arrangement of the two radial electrode patterns of the device of FIG. 1 according to examples;

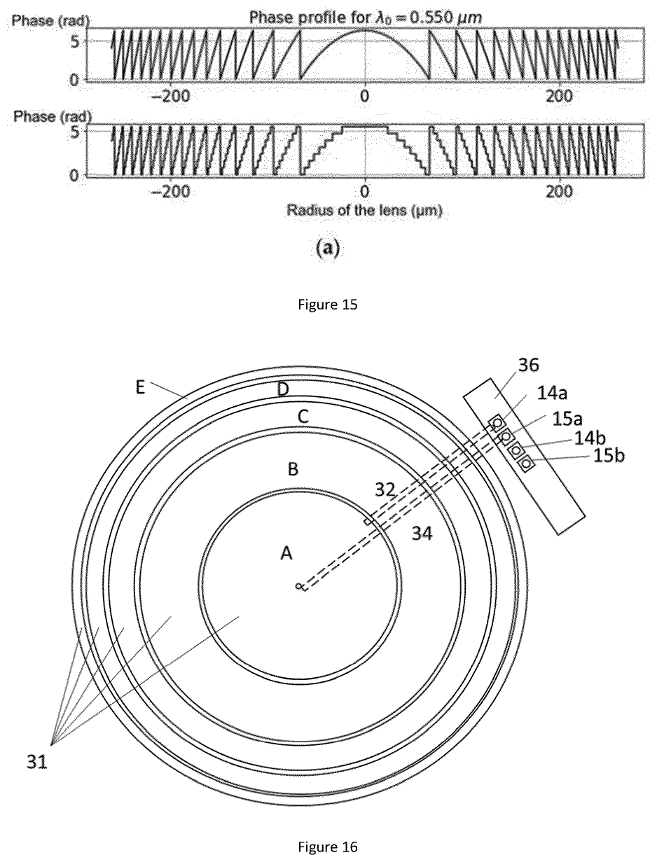

FIG. 15 illustrates refractive index profiles for a positive Fresnel lens according to examples;

FIG. 16 shows a representation of an electrode pattern for both sides of a Fresnel LC lens device according to examples;

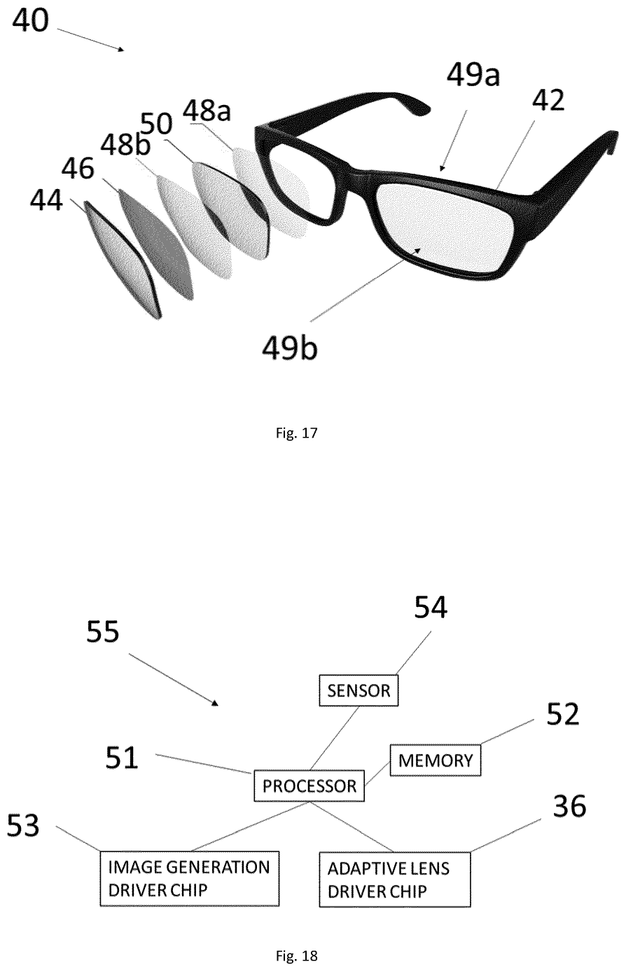

FIG. 17 shows a headset incorporating a liquid crystal, adaptive optical lens according to examples;

FIG. 18 shows a representation of a system for operating the headset of FIG. 17; and

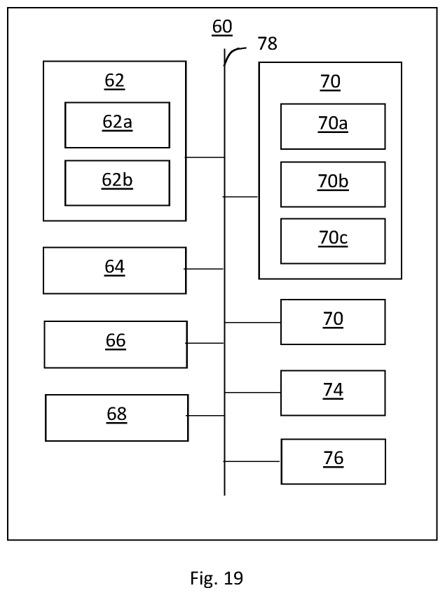

FIG. 19 shows schematically apparatus according to examples.

Examples herein relate to a liquid crystal device comprising a liquid crystal cell comprising liquid crystal material. The liquid crystal cell comprises a first electrode pattern for creating a first radial refractive index pattern in a first region of the liquid crystal material and a second electrode pattern for creating a second radial refractive index pattern in at least the first region. A radial refractive index pattern for example refers to the spatial variation in the refractive index of the liquid crystal material radially. For example, the radial refractive index pattern may be considered to refer to the change in the refractive index of the liquid crystal material, within a plane of the liquid crystal material, from a central point within the plane towards a periphery of the plane. Such a plane may for example be substantially perpendicular to a light propagation axis for light to propagate through the liquid crystal device, in use. The liquid crystal device in these examples is switchable between activating the first electrode pattern and activating the second electrode pattern. This means that the first radial refractive index pattern and the second radial refractive index pattern can each be obtained in at least the first region, depending on which of the first electrode pattern and the second electrode pattern is activated. In this way, the liquid crystal cell may be switched between two different radial refractive indices in a straightforward manner. The number of different radial refractive index patterns obtainable by the liquid crystal cell according to examples may thus be greater than in a liquid crystal cell that is only capable of achieving a single radial refractive index pattern. Changing the radial refractive index may be used to alter the focusing effect achieved by the liquid crystal device. The focusing effect of the liquid crystal device may therefore be controlled in a flexible manner.

In examples, the first and second electrode patterns have different radial resistance profiles. This is a relatively straightforward way to configure the first and second electrode patterns to be capable of creating first and second radial refractive index patterns in at least the first region, depending on the electric potentials applied to the first and second electrode patterns, respectively.

In examples, the liquid crystal device is switchable between activating the first electrode pattern and activating the second electrode pattern to switch between a first focal power, with the first electrode pattern activated, and a second focal power, with the second electrode pattern activated. In some examples, the first focal power is a positive focal power and the second focal power is a negative focal power (although in other examples, the first focal power is a negative focal power and the second focal power is a positive focal power). In such examples, switchability between a positive and a negative focal power can thus be achieved in a liquid crystal cell (e.g. a single liquid crystal cell).

A liquid crystal device according to examples comprises at least one liquid crystal cell as shown in FIG. 1. The liquid crystal cell comprises liquid crystal material 16 contained between two half-cells 2a, 2b. Each half-cell 2a, 2b comprises a single flexible support film 4a, 4b (e.g. flexible organic polymer film such as a cellulose triacetate (TAC) film) supporting a stack of layers formed in situ on the support film. The stack of layers includes a patterned conductor layer 8a, 8b defining a conductor line from a radially central part of the active region of the cell to a peripheral area outside the active region of the cell. The active region of the cell is the region of the cell over which a radial refractive index pattern is created in the liquid crystal material 16 as part of normal operation of the liquid crystal device. Over the patterned conductor layer 8a, 8b is a patterned insulator layer 10a, 10b defining vias down to the conductor line of the patterned conductor layer 8a, 8b. Over the patterned insulator layer 10a, 10b is a patterned layer of electrode material (e.g. indium-tin-oxide (ITO)) defining an electrode pattern. The patterned layer of electrode material contacts the bus line through the vias defined by the patterned insulator layer 10a, 10b. Terminals 14a, 15a, 14b, 15b outside the active region enable the output of a power supply to be connected across a radially central part of the electrode pattern and a radially outer part of the electrode pattern. After forming the electrode pattern, a liquid crystal alignment layer 12a, 12b (e.g. rubbed polyimide layer) is formed to interface the liquid crystal material 16.

FIGS. 2 and 3 illustrate a pair of radial electrode patterns 6a, 6b for the half-cells 2a and 2b, according to examples. In these examples, upon assembly of the two half-cells 2a and 2b, the pair of radial electrode patterns 6a, 6b are centred on a common axis 18. Radial electrode pattern 6a generates a RI pattern (when radial electrode pattern 6b is held at ground potential) in the whole of the device region in which the other radial electrode pattern 6b generates a RI pattern (when radial electrode pattern 6a is held to ground), and vice versa. According to further examples in accordance with FIGS. 13 and 14, though, upon assembly of the two half-cells 2a and 2b, the pair of radial electrode patterns are offset (Ad between the centres of the two radial electrode patterns) from one another in a direction parallel to the planes of the radial electrode patterns 6a, 6b. The region in which radial electrode pattern 6a generates a refractive index (RI) pattern (when radial electrode pattern 6b is held at ground potential) occupies only part of the device region in which the other radial electrode pattern 6b generates a RI pattern, and vice versa. In this example variation illustrated by FIGS. 13 and 14, a common electrode 6c is provided at the same level of half-cell 2a as radial electrode pattern 6a, to provide a counter electrode for the part of the other radial electrode pattern 6b that is outside the region occupied by radial electrode pattern 6a; and a common electrode 6d is provided at the same level of half-cell 2b as radial electrode pattern 6b, to provide a counter electrode for the part of the other radial electrode pattern 6a that is outside the region occupied by radial electrode pattern 6b. When radial electrode pattern 6a is activated, radial electrode pattern 6b and counter electrode 6d are maintained at the same counter potential, to together provide the counter electrode for the whole of radial electrode pattern 6a; and when radial electrode pattern 6b is activated, radial electrode pattern 6a and common electrode 6c are held at the same counter potential, to together provide the counter electrode for the whole of radial electrode pattern 6b. In FIGS. 13 and 14, the lines indicate the borders of the regions occupied by the radial electrode patterns 6a and 6b and the common electrodes 6c and 6d. In FIGS. 13 and 14, a radially outer border of common electrode 6c substantially aligns with a part of radially outer border of radial electrode pattern 6b, and a radially outer border of common electrode 6d substantially aligns with a part of radially outer border of radial electrode pattern 6b. Common electrode 6c may or may not be patterned within the region occupied by radial electrode pattern 6b; and common electrode 6d may or may not be patterned within the region occupied by radial electrode pattern 6a.

In FIGS. 2 and 3, each electrode pattern comprises a series of concentric rings 20a, 20b centered on a common axis 18, and respective links 22a, 22b between each pair of adjacent concentric rings 20a. In other examples, the links 22a, 22b may be formed from a different material to the electrode material of the concentric rings 20a, 20b. For each radial electrode pattern 6a, 6b, the concentric rings 20a, 20b are of equal area, whereby the series of outer radii of the concentric rings 20a, 20b exhibits a parabolic pattern, as shown in FIG. 8. According to one example variation, the series of outer radii of the concentric rings 20a 20b exhibits another aspheric pattern. For radial electrode pattern 6a, the links 22a between adjacent concentric rings 20a are configured to exhibit sequential decreases in resistance towards the common axis; and for radial electrode pattern 6b, the links 22b between adjacent concentric rings 20b are configured to exhibit sequential increases in resistance towards the common axis 18. A sequential change in resistance of links may involve a constant or different amount of change in a magnitude of resistance between adjacent links, and resistances between a series of links may decrease and then increase in a direction towards the common axis (and vice versa), as shown in FIGS. 11 and 12. In some examples, a first link of a first set of links 22a has a larger resistance than a second link of the first set of links 22a radially outward of the first link of the first set of links 22a and a first link of a second set of links 22b has a smaller resistance than a second link of the second set of links 22b radially outwards of the second link of the second set of links 22b.

In examples, such as that of FIGS. 2 and 3, a first set of concentric rings 20a of a first electrode pattern 6a may substantially match a second set of concentric rings 20b of a second electrode pattern 6b. For example, the first and second sets of concentric rings may match each other within manufacturing tolerances and/or measurement uncertainties. The first and second sets of concentric rings may be the same as each other or substantially the same as each other but arranged in a different spatial location within the liquid crystal cell, e.g. both centred on a common axis 18 but with a vertical offset therebetween, so that the first set of concentric rings 20a overlaps the second set of concentric rings 20b as shown in FIG. 1. In examples, the first set of concentric rings may correspond to (e.g. substantially match, match, have a close similarity to, or otherwise resemble) the second set of concentric rings in at least one of: an area of each ring (e.g. in a plane perpendicular to an axis on which at least one of the radial electrode patterns 6a, 6b is centred, such as the common axis 18 in FIG. 1), a radius of each ring (e.g. in the plane), a depth of each ring (e.g. in a direction perpendicular to the plane), a material of each ring (e.g. a material, such as a compound or chemical composition, of or comprised by each ring), a spacing between each pair of adjacent rings (e.g. in the plane), or a number of rings.

FIGS. 4 and 5 illustrate one example of a pair of resistance profiles for the pair of radial electrode patterns 6a and 6b.

FIGS. 9 to 12 illustrate radial electrode patterns 6a and 6b, each comprising a plurality of concentric sections across which an electric potential difference may be applied in parallel, according to further examples. For clarity, FIGS. 9 and 10 show only a radially inner part of the radial electrode patterns 6a and 6b according to these examples; FIGS. 11 and 12 show the resistance profiles for the full electrode patterns according to these examples, including the radially outer parts not shown in FIGS. 9 and 10.

According to these examples: each radial electrode pattern 6a, 6b comprises a plurality of concentric sections across which an electrical potential difference may be applied in parallel. Each concentric section of a radial electrode pattern comprises a set of concentric rings and links connecting the concentric rings of the concentric section. FIGS. 11 and 12 show a pair of radial resistance profiles for such a pair of radial electrode patterns each comprising three concentric sections, according to examples. For one electrode pattern of these examples, the links in each concentric section decrease in electrical resistance radially inwards, and there is a re-set increase in electrical resistance between the radially innermost link of a concentric section and the radially outermost link of the radially inwards adjacent concentric section. In other words, the electrical resistance of the radially innermost link of a concentric section of the electrode pattern is larger than that of the radially outermost link of the radially inwards adjacent concentric section by a predetermined, or otherwise set, amount. In some examples, the electrical resistance of the radially innermost link of each concentric section of the electrode pattern is substantially the same as each other. For the other electrode pattern of these examples, the links in each concentric section increase in electrical resistance radially inwards, and there is a re-set decrease in electrical resistance between the radially innermost link of a concentric section and the radially outermost link of the radially inwards adjacent concentric section. In other words, the electrical resistance of the radially innermost link of a concentric section of the other electrode pattern is smaller than that of the radially outermost link of the radially inwards adjacent concentric section by a predetermined, or otherwise set, amount. In some examples, the electrical resistance of the radially innermost link of each concentric section of the other electrode pattern is substantially the same as each other.

FIG. 15 shows refractive index (RI) profiles (for a positive Fresnel lens) achievable by the multi-section electrode patterns described above, according to examples.

The links 22a, 22b provide an in-line resistor network. A difference in electrical resistance between links may be achieved by configuring the links to have substantially the same cross-sectional area but different lengths, such as the same cross-sectional area within manufacturing and/or measurement tolerances. According to further examples, a difference in electrical resistance between links may be achieved by configuring the links to have both different widths and different lengths. According to yet further examples, the electrical resistance of the concentric rings themselves may make a significant contribution to the electrical resistance profile.

The exact configuration of each series of links 22a, 22b will depend on the liquid crystal material, and more particularly the relationship between (i) the refractive index of the liquid crystal material and (ii) the magnitude of the electrical potential difference across the liquid crystal material 16. For a liquid crystal material for which this relationship is not a linear relationship; a sequential change in resistance of the links towards the common axis 18 can account for the non-linear relationship, to enable the electrode pattern to achieve a substantially parabolic refractive index pattern in the liquid crystal material 16.

FIGS. 6 and 7 show a representation of circuitry for switching between: (i) applying the live output of a power supply to the radially inner terminal 15a of the electrode pattern 6a of FIG. 2, and grounding the radially outer terminal 14a of the electrode pattern 6a of FIG. 2 and both terminals 15b, 14b of the electrode pattern 6b of FIG. 3 (as shown in FIG. 6); and (ii) applying the live output of power supply 30 to the radially outer terminal 14b of the electrode pattern 6b of FIG. 3, and grounding the radially inner terminal 15b of the electrode pattern 6b of FIG. 3 and both terminals 14a, 15a of the electrode pattern 6a of FIG. 2 (as shown in FIG. 7).

According to this (DC drive) example of activating the lens, the electric potential at the concentric electrodes on one side of the LC material 16 is constant in terms of polarity over time relative to the electric potential at the electric potential at the concentric electrodes on the other side of the LC material 16. According to another (AC drive) example for activating the concentric electrodes, the electric potential at the concentric electrodes on one side of the LC material is alternated over time in terms of polarity relative to the electric potential at the concentric electrodes on the other side of the LC material 16, at a high switching frequency of e.g. about 60 Hz or above. The AC drive example may help to better protect the molecules of the LC material 16. According to one example, the device is switched between (i) applying synchronised AC voltage waveforms having relatively high and low amplitudes to terminals 15a and 14a, respectively, and applying a reference COM electric potential (e.g. 0V) to both the terminals 14b and 15b; and (ii) applying synchronised AC voltage waveforms having relatively high and low amplitudes to terminals 14b and 15b, respectively, and applying a reference COM electric potential (e.g. 0V) to both the terminals 14a and 15a. The sizes of the amplitudes of the synchronised AC voltage waveforms control the size of RI distribution generated in the LC material and thus control the optical power (dioptres) of the device.

When the live output of power supply 30 is applied to the radially inner terminal 15a of the electrode pattern 6a of FIG. 2, and the radially outer terminal 14a of the electrode pattern 6a of FIG. 2 and both terminals 14b, 15b of the electrode pattern 6b of FIG. 3 are grounded (as shown in FIG. 6), or e.g. when the above-mentioned synchronised AC voltage waveforms having relatively high and low amplitudes are applied to terminals 15a and 14a, respectively, and reference COM electric potential (e.g. 0V) is applied to both the terminals 14b and 15b: the electrical potential difference across the liquid crystal material 16 decreases towards the common axis 18, and the refractive index of the liquid crystal material 16 increases towards the common axis (since the refractive index of the liquid crystal material decreases as the electrical potential difference across the liquid crystal material 16 increases). The radial resistance profile of the electrode pattern 6a of FIG. 2 is configured to achieve in the electrode pattern 6a a radial electric potential profile that produces the substantially parabolic radial variation in refractive index required for enabling a negative focal power.

Similarly, when the live output of power supply 30 is applied to the radially outer terminal 14b of the electrode pattern 6b of FIG. 3, and the radially inner terminal 15b of the electrode pattern 6b of FIG. 3 and both terminals 14a and 15a of the electrode pattern 6a of FIG. 2 are grounded (as shown in FIG. 7), or e.g. when the above-mentioned synchronised AC voltage waveforms having relatively high and low amplitudes are applied to terminals 14b and 15b, respectively, and reference COM electric potential (e.g. 0V) is applied to both the terminals 14a and 15a: the electric potential difference across the liquid crystal material 16 increases towards the common axis 18, and the refractive index of the liquid crystal material decreases towards the common axis (since the refractive index of the liquid crystal material decreases as the electric potential difference across the liquid crystal material increases). The radial resistance profile of the electrode pattern 6b of FIG. 3 is configured to achieve in the electrode pattern 6b a radial electric potential profile that produces the substantially parabolic radial variation in refractive index required for enabling a positive focal power.

For Fresnel lens devices having the kind of multi-section electrode patterns illustrated in FIGS. 9 to 12, the electrical circuitry is appropriately modified such that an electrode pattern (i) may be activated by applying a potential difference in parallel across each of the concentric sections of the electrode pattern, and (ii) may serve as a counter electrode by holding each concentric section of the electrode pattern at ground potential.

FIG. 16 shows a representation of an electrode pattern comprising concentric sections 31 (A to E) for both sides of the LC material 16 in a Fresnel lens device according to some example embodiments. For one side of the LC material 16, terminal 14a is connected via bus conductor line 32 to the outermost radial concentric electrode of each concentric section A to E, and terminal 15a is connected via bus conductor line 34 to the radially innermost concentric electrode of each concentric section A to E. On the other side of the LC material 16, terminal 14b is connected via a bus conductor line to the outermost radial concentric electrode of each concentric section A to E, and terminal 15b is connected via bus conductor line 34 to the radially innermost concentric electrode of each concentric section A to E. A driver chip 36 is connected to the terminals 14a, 14b, 15a, 15b via pins of the driver chip.

According to one (DC drive) example of activating the lens, the electric potential at the concentric electrodes of concentric sections A to E on one side of the LC material 16 is constant in terms of polarity over time relative to the electric potential at the concentric electrodes of concentric sections A to E on the other side of the LC material. According to another (AC drive) example for activating the lens, the electric potential at the concentric electrodes of each of the concentric sections A to E on one side of the LC material 16 is alternated over time in terms of polarity relative to the electric potential at the concentric electrodes of each of the concentric sections A to E on the other side of the LC material 16, at a high switching frequency of e.g. about 60 Hz or above. The AC drive example may help to better protect the molecules of the LC material. According to one example: synchronised AC voltage waveforms having relatively high and low amplitudes are applied to terminals 15a and 14a respectively, and a reference COM electric potential (e.g. 0V) is applied to terminals 14b and 15b; or synchronised AC voltage waveforms having relatively high and low amplitudes are applied to terminals 14b and 15b respectively, and a reference COM electric potential (e.g. 0V) is applied to terminals 14a and 15a. The sizes of the amplitudes of the synchronised AC voltage waveforms control the size of RI distribution generated in the LC material and thus control the optical power (dioptres) of the device. In this simple example, four inputs from the driver chip 36 (to each of four terminals 14a, 15a, 14b, 15b and four respective busbars) are used, but other examples may include more busbars, and more respective inputs to those busbars via respective terminals. As illustrated by FIGS. 4 and 5 (or by FIGS. 11 and 12), the radial resistance profiles for electrode patterns 6a and 6b are different to each other, in order to achieve the different kinds of electrical potential profiles in the same pattern of concentric rings 20a, 20b, in these examples.

Accordingly, the liquid crystal material 16 can be switched between a positive focal power configuration and a negative focal power configuration, in examples.

A liquid crystal device may comprise a stack of the liquid crystal cells according to examples herein. Including at least one liquid crystal cell in accordance with the examples described above in the stack may enable a reduction in the number of liquid crystal cells required to achieve a given function or range of functions, such as a range of focal powers between a positive maximum focal power and a maximum negative focal power. A reduction in the number of the liquid crystal cells can reduce light absorption, scattering, haze and internal reflections; and can also reduce design and manufacturing complexity.

The optical quality obtainable using a liquid crystal cell may be inversely related to the focusing power of the liquid crystal cell, as increasing the focal power of a liquid crystal cell may increase light absorption, scattering and so forth, and therefore reduce the optical quality. However, examples herein with at least one liquid crystal cell that provides the capability of switching between a positive and negative focal power may improve the optical quality achievable for a particular focusing power. As an example, a focusing power (sometimes referred to as an optical power) of between −1 and +1 dioptres may be obtained with a device comprising a stack of two liquid crystal cells according to examples herein, each with an individual focusing power of between −0.5 and +0.5 dioptres. Such a device may provide an improved optical quality than a device that provides the same focusing power of between −1 and +1 dioptres but using a stack of one liquid crystal cell that is controllable to provide negative focusing powers of between −1 and 0 dioptres and another liquid crystal cell that is controllable to provide positive focusing powers of between 0 and +1 dioptres.

The liquid crystal device described above may, for example, function as or be used within a switchable lens device or a beam steering device. For example, a device may be or comprise an adaptive optical lens comprising a liquid crystal device according to any of the examples herein. Such a device may be or comprise a headset, which may be referred to as a head-mounted display (HMD).

The liquid crystal device described above is useful in a wide range of applications, including ophthalmic lenses (such as spectacle lenses), virtual reality (VR), mixed reality (MR) and augmented reality (AR) headsets; optical projectors; photographic devices; and communication devices.

For example, the LC optical lens device may be used for a push lens, a pull lens or a combined push/pull lens of an augmented reality (AR) headset such as e.g. that shown in FIG. 17. The headset 40 comprises a support frame 42 supporting optical components arranged in optical series in front of the user's eye. The optical components include: (i) a push lens 48a, a waveguide 50 and a pull lens 48b for presenting a virtual object to the user; (ii) a front window/lens 44; and (iii) a variable dimmer device 46 between (ii) the front window/lens 44 and (i) the optical components for presenting a virtual object to the user.

At least one optical component such as one or more of the optical components shown in FIG. 17 may be considered to correspond to or be part of an assembly, which may be considered to be a display stack, comprising at least one liquid crystal cell according to examples herein. In examples, such as that of FIG. 17, such an assembly includes a stack of liquid crystal cells according to examples herein. In the example of FIG. 17, the push lens 48a includes at least one liquid crystal cell (e.g. a stack of liquid crystal cells), the pull lens 48b includes at least one liquid crystal cell (e.g. a stack of liquid crystal cells), and the assembly includes the push lens 48a, the waveguide 50, the pull lens 48b, the variable dimmer device 46, which is an example of a luminance adjustment component, and the front window/lens 44. Examples in which an assembly includes two liquid crystal cells spatially separated from each other (e.g. such as an assembly with a push lens 48a with a liquid crystal cell and a pull lens 48b with a liquid crystal cell) may nevertheless be considered to include a stack of liquid crystal cells, for example where the liquid crystal cells are both within a field of view of the same eye as each other so that the liquid crystal cells lie in an optical path for light to travel through the assembly and into the eye. Liquid crystal cells of a stack may be aligned along a common optical axis (such as the common axis 18 of FIG. 1). In some cases, though, optical axes of at least two of the liquid crystal cells of a stack may be offset from each other in a direction parallel to a plane of a radial electrode pattern of at least one of the liquid crystal cells (such as in the example of FIGS. 13 and 14), provided that light traversing the assembly traverses the liquid crystal cells of the stack. FIG. 17 only shows the optical components for one half of the headset, but a matching set of optical components is also provided for the other half of the headset.

The waveguides 50 of the headset respectively display left and right perspectives of one or more virtual reality objects, by which the user perceives the one or more virtual reality objects as 3D objects. Alternatively, other mechanisms may be employed to display the left/right perspectives of the one or more virtual reality objects, such as e.g. laser projection.

The degree to which the user's left and right eyes need to rotate relative to each other such that the left and right perspectives of a virtual reality object are simultaneously directed onto the foveas (which are the parts of the retina responsible for sharp central vision necessary for activities for which visual detail is of primary importance) of respective left and right eyes of the user determines the distance at which the user perceives the virtual reality object to be. This mechanism is referred to as vergence.

The LC optical lens device described above may be used as an adaptive lens device to control the location at which the user's eyes perceive the left/right perspectives of a displayed virtual reality object in focus (i.e. not blurred), which location may be referred to as a focal plane. In other words, the LC optical lens device described above may be used as an adaptive lens device to control the degree to which the lenses in the user's eyes need to adapt to perceive the left and right perspectives of the virtual reality object in focus (i.e. not blurred). This adaptation mechanism of the lenses in the user's eyes is known as accommodation.

The LC optical lens device described above may be used to produce optical images (real or virtual) of the left/right perspectives of a virtual reality object substantially at the distance from the user's eyes at which the user perceives the virtual reality object to be located through the vergence mechanism discussed above. This may allow the user to perceive a focussed 3D image of the virtual reality object without disrupting the vergence-accommodation reflex, by which the focussing action of the lenses in the user's eyes (accommodation) is unconsciously linked to the above-mentioned rotation of the left and right eyes relative to each other (vergence). In other words, the LC optical lens device may be used to avoid or reduce the strain on the user's eyes that can arise from a conflict between the vergence and accommodation mechanisms (referred to as the vergence-accommodation conflict). For example, the LC optical lens device may be switchable between a positive focal power, with the first electrode pattern activated, and a negative focal power, with the second electrode pattern activated.

Hence, a liquid crystal device according to examples herein may provide a lower complexity and/or higher quality system to actively adjust focus to compensate for focal differences between a virtual object and a real-world environment visible to a user of a headset through the optical components mounted in front of each eye. This for example allows the perceived and actual image depth to be brought together in a consistent manner, improving user comfort.

In FIG. 17, the headset 40 permits transmission of light from a real-world environment around the headset 40 at least partly through the optical components and into the user's eyes. In this example, the optical components are at least partly transparent. On a bright day, the luminance of the environment may be significantly higher outdoors than indoors, such as around 100 times higher. This can lead to a virtual object appearing washed out and difficult to see when the user operates the headset outdoors, unless the luminance of the light transmitted from the environment to the user is appropriately controlled. In FIG. 17, the variable dimmer device 46 controls the amount of light transmitted through the optical components and towards the eyes, e.g. so as to reduce the luminance of light from the environment transmitted towards the user in bright conditions, and may be used to provide ambient dimming to dim ambient light transmitted through the headset 40.

The variable dimmer device 46 may provide so-called global dimming, in which the luminance of the light from the environment is adjusted by substantially the same amount within an extent of a plane of the variable dimmer device 46 facing the user (e.g. to reduce the luminance of the light by substantially the same amount across an entire surface area of the variable dimmer device 46). In other words, with global dimming can allow the luminance of the light transmitted through the variable dimmer device 46 to be controlled in a substantially spatially uniform manner (e.g. so as to provide a substantially spatially uniform reduction in the luminance across a field of view of the user). The variable dimmer device 46 may also or alternatively provide local dimming, in which the variable dimmer device 46 is adjustable to control the luminance of the light transmitted from the environment on an area-by-area basis (where an area may correspond to a single pixel or a plurality of pixels). Variable dimming may involve adjusting the luminance across less than all of the surface area of the variable dimmer device 46, such as within a sub-area which is smaller than the surface area of the variable dimmer device 46. In other cases, though, variable dimming may involve adjusting the luminance across the entire surface area of the variable dimmer device 46 but by different amounts in at least two portions of the surface area.

Although not shown in FIG. 17, it is to be appreciated that the headset 40 may be configured to obtain luminance data, e.g. from a light sensor of the headset 40, indicative of the luminance of the light within the environment of the headset 40. For example, if a first side 49a of the headset 40 is configured to face the user, with the headset 40 mounted on the head of the user, the headset 40 may include a light sensor to detect the luminance of light at a second side 49b of the headset 40, opposite to the first side 49a. The variable dimmer device 46 may be controlled at least partly based on the luminance data, so as to adjust the luminance of light transmitted from the second side of the headset 40 towards the user, to improve the visibility of the virtual object displayed to the user by the headset 40.

In the example of FIG. 17, a first lens comprising at least one liquid crystal cell of the examples herein (the push lens 48a) is located between the waveguide 50 and the eye, with the headset 40 in use. Light representative of the virtual object is generated and transmitted to the waveguide 50, which directs the light through the push lens 48a and into the eye. The push lens 48a has a focusing effect to focus the light representative of the virtual object so that the object appears in focus to the user. For example, the virtual object may be generated so that it is in focus at a focal plane of infinity. The push lens 48a may then bring the virtual object into focus at a focal plane which is closer to the user than infinity, to allow the user to focus on the virtual object more comfortably. The focal plane at which the virtual object is to be brought into focus, and hence the focusing power to be applied by the push lens 48a, may be determined based on eye tracking data, e.g. obtained by a suitable sensor as discussed further below, which is indicative of a direction in which the eye of the user is looking.

Prior to use of the headset 40, the external environment may appear in focus to the user. However, in the absence of the pull lens 48b, light from the external environment would be at least partly transmitted through the waveguide 50 and through the push lens 48a and would therefore be subject to the focusing effect provided by the push lens 48a. This would distort the external environment as viewed by the user through the headset 40. To compensate for the distortion introduced by the push lens 48a, the headset 40 of FIG. 17 includes a second lens (the pull lens 48b) positioned at an opposite side of the waveguide 50 to the push lens 48a. The pull lens 48b applies an appropriate focusing effect to light from the environment traversing the pull lens 48b to at least partially compensate for or otherwise reduce the focusing effect introduced by the push lens 48a. For example, the push and pull lenses 48a, 48b may provide opposite focusing effects to each other, e.g. with substantially equal magnitudes but opposite signs. As an example, one of the push and pull lenses 48a, 48b may provide a positive focusing power and the other one of the push and pull lenses 48a, 48b may provide a negative focusing power, which may be substantially equal in magnitude.

In examples at least one lens of examples herein (such as at least one of the push lens 48a and the pull lens 48b, and in some cases both the push and pull lenses 48a, 48b) each includes a so-called doublet of liquid crystal cells according to examples herein. A doublet is a stack of two liquid crystal cells. The focusing effect of a liquid crystal-based lens may depend on the polarization of the light incident on the lens. Rather than using a separate polarizer component, using a doublet such as this may provide an appropriate focusing effect with improved light transmission; in some examples this is achieved by positioning one liquid crystal cell of the doublet orthogonal to the other liquid crystal cell of the doublet, with respect to the respective orientation of polarization that each liquid crystal cell is configured to modify light for.

FIG. 17 shows an example of a push lens 48a and a pull lens 48b in combination with various other optical components. It is to be appreciated that a liquid crystal cell in accordance with examples herein can be used in combination with different optical component(s) than those shown in FIG. 17, to provide further flexibility in functionality. This may further reduce the size and/or weight of apparatus including the liquid crystal cell and/or improve optical performance of the apparatus. For example, an assembly, such as a display stack, including a liquid crystal cell in accordance with examples herein may include a reflection-reduction layer (such as an anti-reflection (AR) coating), which may be laminated to another optical component of the assembly, such as the front window/lens 44, and/or a protective layer (such as a hard coat) to protect the assembly from damage, e.g. due to abrasion, and/or wear due to exposure to environmental conditions.

In examples, the liquid crystal device comprises electrical terminals electrically connected to the first and second electrode patterns. The electrical terminals for example allow a potential difference to be applied between the first and second electrode patterns. As explained above, the electrical potential applied to an electrical terminal can be controlled by a suitable control system, e.g. so that the liquid crystal device is switchable between activating the first electrode pattern and activating the second electrode pattern. For example, the liquid crystal device may be switched between applying a potential difference across the electrical terminals connected to the first electrode pattern and applying a potential difference across the electrical terminals connected to the second electrode pattern.

Further examples relate to a system comprising a liquid crystal device according to any of the examples herein, and a driver chip connected to the electrical terminals. FIG. 18 illustrates a system 55 in accordance with these examples. With reference to FIG. 18, a system 55 according to these examples comprises a processor 51 operating on the basis of computer program code stored in memory 52 to control an image generation driver chip 53 to cause an image generation system to generate images of left/right perspectives of one or more virtual reality objects, by which the user may perceive 3D images of the virtual reality objects, and display the images via the waveguide 50. Although not shown in FIG. 18, it is to be appreciated that there may be two waveguides: one to display an image of a left perspective of a virtual reality object to a left eye and another to display an image of a right perspective of a virtual reality object to a right eye, as discussed further with reference to FIG. 17. There may further be two image generation systems: one to generate the image of the left perspective of the virtual reality object and another to generate the image of the right perspective of the virtual reality object (although in some cases a single image generation system may generate both images or an image generation system may generate a single image to be displayed to both eyes). An image generation system is discussed further below with reference to FIG. 19. Inputs from sensors 54 feed into the processor 51 to enable the processor 51 to control positions at which the virtual reality objects are displayed by the waveguide 50, for seamless overlay of the one or more virtual reality objects into the user's view of the user's real environment.

Based on inputs fed into the processor 51 from one or more sensors 54 sensing the movement of the user's eyes and/or based on the content being displayed by the waveguide 50, the processor 51 controls an adaptive lens driver chip 36 to control the electrical inputs to terminals 14a, 14b, 15a, 15b to achieve the optical focussing power (Dioptres) required to achieve the above-described generation of optical images of the display output of the waveguide at a distance from the user's eyes at which the virtual content that the user is determined to be looking at (e.g. through tracking of the user's eyes) is intended to be perceived by the user (through the vergence mechanism described above). A driver chip is an example of a controller, which may be implemented in hardware, e.g. via suitably configured circuitry. In some cases, a driver chip may include or be considered to implement at least one processor.

FIG. 19 illustrates schematically hardware architecture of apparatus 60 according to further examples. The apparatus 60 comprises at least one liquid crystal cell in accordance with examples herein. In FIG. 19, the apparatus 60 is configured to be mounted on human head, e.g. a head of a user, with a liquid crystal cell positioned in a field of view of an eye of the head, in use. In the example of FIG. 19, the apparatus 60 is an AR headset for displaying a virtual image to a wearer of the headset, and may be similar to or the same as the headset 40 of FIG. 17. In other examples, though, apparatus including a similar hardware architecture to the apparatus 60 of FIG. 19 may be configured for a different purpose, may include additional components and/or may omit at least one of the components illustrated in FIG. 19.

The apparatus 60 of FIG. 19 includes an optical system 62, an image generation system 64, at least one processor 66, storage 68, at least one sensor 70, a user input/output interface 72, a communications system 74 and at least one further hardware system 76. Components of the apparatus 60 are connected to each other via at least one bus 78, which may be or include any suitable interface or bus for transferring data between the illustrate components.

The optical system 62 includes a first assembly and a second assembly, which in this example are a first display stack 62a and a second display stack 62b, respectively. The first display stack 62a comprises a first set of optical components, e.g. arranged as a stack of layers. The apparatus 60 is configured to permit at least partial transmission of light from an external environment through the first display stack 62a and towards a first eye of the user, with the apparatus 60 in use and mounted on the head. In other words, where the apparatus 60 has a first side configured to face the user, in use (e.g. the first side 49a of FIG. 17), the first display stack 62a is arranged for directing light from the second side towards the first eye (in this case, through the first display stack 62a). The first display stack 62a in this case includes the optical components shown in FIG. 17, i.e. the push lens 48a, the waveguide 50, the pull lens 48b (where the push and pull lenses 48a, 48b are each an example of a liquid crystal device according to examples herein), the variable dimmer device 46 and the front window/lens 44. The push lens 48a and/or the pull lens 48b of the first display stack 62a may be considered to be a first lens comprising a first at least one of the liquid crystal cells according to examples herein. The first lens is configured to be positioned in a first field of view of a first eye, e.g. the first eye of a user, in use.

In FIG. 19, the second display stack 62b comprises a second set of optical components, which in this example is the same as the first set of optical components but configured to transmit light towards a second eye of the user, with the apparatus 60 in use. In other words, the second display stack 62b is arranged to direct light from the second side of the apparatus 60 towards the second eye. Hence, in this example, the push lens and/or the pull lens of the second display stack 62b may be considered to be a second lens comprising a second at least one of the liquid crystal cells according to examples herein. The second lens is configured to be positioned in a second field of view of a second eye, e.g. the second eye of the user, in use. It is to be appreciated that the first lens may be visible to solely the first eye or to both the first and second eye, in use, and the second lens may be visible to solely the second eye or to both the first and second eye, in use.

A spatial arrangement of elements of the second display stack 62b in at least one layer of the stack may mirror the spatial arrangement of corresponding elements of the first display stack 62a in the corresponding layer of the stack of the first optical arrangement 62a as reflected in a sagittal plane of the apparatus 60 (which may be referred to as a longitudinal plane of the apparatus 60, and e.g. separates left and right sides of the apparatus, with the apparatus in use). In other cases, though, the first and second display stacks 62a, 62b may have a different structure from each other. It is to be appreciated that the optical system 62 may include further components, e.g. further optical components, not shown in FIG. 19.

The apparatus 60 also includes an image generation system 64 to generate an image of a virtual object to be displayed to the user of the apparatus 60 so that the virtual object appears to the user to be overlaid on top of the external environment, which is at least partly visible to the user through the optical system 62. The image generation system 64 may be or include a display device to generate an image (e.g. of a virtual object) for display by the apparatus 60 to the user. The display device may be a liquid crystal display (LCD) device, a light emitting diode (LED) display device such as an organic light emitting diode (OLED) display device, an electroluminescent (EL) display device and so forth. In the example of FIG. 19, the image generation system 64 is in optical communication with the optical system 62. For example, the image generation system 64 may be housed by the support frame 42 if the apparatus 60 is in the form of the headset 40 of FIG. 17. Light generated by the image generation system 62 representing the virtual object may be transmitted to the optical system (e.g. to a waveguide such as the waveguide 50 shown in FIG. 17) either directly (e.g. without traversing another optical component) or via at least one further optical component. In some cases, the image generation system may include two display devices, a first one for the first eye and a second one for the second eye, e.g. if it is desired to display a first image to the first eye and a second image to the second eye. In other examples, a single display device may be used to generate an image to be display to both the first and second eyes.

In the example of FIG. 19, the image generation system 64 is shown as a separate system from the optical system 62. In other examples, though, the image generation system may form part of the optical system. For example, an assembly, such as a display stack, of the optical system may include an image generation system, such as a display device.

The at least one processor 66 of the apparatus 60 may be a single processor or a plurality of processors of one or more types. Components of the at least one processor 66 may be implemented using suitably programmed hardware, e.g. in the form of circuitry. The at least one processor 66 may include a central processing unit (CPU), a graphics processing unit (GPU) and/or a neural processing unit (NPU), which may be referred to as a neural network accelerator.

In some examples, apparatus such as the apparatus 60 of FIG. 19 includes driving circuitry connected to at least one electrical connection connected to the first and second electrode patterns (such as the terminals 14a, 15a, 14b and 15b discussed above) to apply a potential difference between at least part of the first electrode pattern and at least part of the second electrode pattern. The potential difference applied between the at least part of the first electrode pattern and the at least part of the second electrode pattern (such as a magnitude and/or timing of the potential difference applied) may be determined by the at least one processor 66 and/or by the driving circuitry, such as by a controller implemented by at least a portion of the driving circuitry, based on the instructions stored in the storage.

If the potential difference is determined by the driving circuitry, the determination of the potential difference may be instigated by instructions received from the at least one processor, such as instructions indicative that a virtual object is to be displayed and that at least one of the electrode patterns are thus to be activated so that the virtual object appears in focus to the user. In this way, the driving circuitry may be agnostic to the at least one processor from which the instructions are received. In other words, the operation of the driving circuitry may for example be independent of the at least one processor used to control the driving circuitry, such that the same effect can be achieved irrespective of the at least one processor coupled to the driving circuitry (provided the at least one processor provides an appropriate indication to the driving circuitry to cause the driving circuitry to determine a suitable potential difference).

The potential difference may be applied to the electrical connection(s) by at least one driver of the driving circuitry, such as the adaptive lens driver chip 36 of FIG. 18, which is an example of a driver. Application of a potential difference by the at least one driver may be considered to amount to so-called “driving” of the electrode pattern(s), via the electrical connection(s). The driving circuitry may be in the form of at least one system-on-a-chip (SoC).

The storage 68 may be or include computer-useable volatile and/or non-volatile memory. The storage 68 may comprise random access memory (RAM) and/or read-only memory (ROM). The storage 68 may be removable or non-removable from the apparatus 60. The storage 68 stores instructions for controlling the apparatus 60 in accordance with examples herein, e.g. to switch between activation of the first electrode pattern and activation of the second electrode pattern of at least one liquid crystal cell of the apparatus 60. Activation of an electrode pattern for example refers to applying a potential difference between at least two connectors connected to the electrode pattern (e.g. between the terminals 14a and 15a for the first electrode pattern and/or between the terminals 14b and 15b for the second electrode, for example as shown in FIGS. 1, 6, 7 and/or 16). The instructions may be in the form of computer-readable and/or executable instructions, e.g. computer program instructions. Although the storage 68 is shown as a separate component to the at least one processor 66 in FIG. 19, in some cases the storage 68 may be or include internal storage of the at least one processor 66, in which cases the at least one processor 66 and the storage 68 may be at least partly integrated into the same system or component.

The at least one sensor 70 in this example is configured to obtain eye tracking data of the apparatus, in use, which for example indicates a direction in which at least one eye of the user is looking, as the skilled person will appreciate. Eye tracking data may be obtained for each eye, or the eye tracking data may be obtained for a single eye or for a combination of both eyes of the user. Suitable sensors for obtaining eye tracking data include a camera 70a for obtaining images of at least one eye of the user, an inertial measurement unit (IMU) 70b for determining an orientation of the apparatus 60 and at least one position sensor 70c such as a global positioning system (GPS) sensor to determine a location of the apparatus 60. As the skilled person will appreciate, an IMU 70b may include at least one accelerator or gyroscope for use in determining the orientation of the apparatus 60. The focusing effect of the at least one liquid crystal cell may be controlled based on the eye tracking data, e.g. so as to reduce user eye strain as described further above.

The apparatus 60 also includes a user input/output interface 72 via which a user can interact with the apparatus 60 to control aspects of the apparatus 60. For example, the user input/output interface 72 may be or include an input device such as a button, a touchscreen, a slider, a controller or any other suitable device for communicating user requests to the apparatus 60 to control the apparatus 60.

The apparatus 60 includes a communications system 74 for receiving data from a remote system, e.g. via a suitable telecommunications network, such as a wireless network, or via some other type of network or connection. The communications system 74 may include an input/output interface, such as a Bluetooth connector, a universal serial bus (USB) connector or a network connector, for receiving the data from the remote system.

The apparatus 60 of FIG. 19 includes at least one further hardware system 76 such as a power source, e.g. a battery, for providing electrical power to the electrical components of the apparatus 60.

Some examples have been described above for the example of an optical focussing device, but the same techniques have application in other areas such as e.g. beam steering optics.

Further examples relate to a method of operating a liquid crystal device according to any of the examples herein, the method comprising switching between (i) applying a potential difference across electrical terminals connected to the first electrode pattern and (ii) applying a potential difference across electric terminals connected to the second electrode pattern. It is to be appreciated that any of the features described in the context of the liquid crystal device herein apply equally to the method of operating the liquid crystal device.

The term “substantially” used herein may be considered to mean that two elements that are “substantially” the same are: the same within manufacturing tolerances, the same within measurement uncertainties and/or are within 5% of each other.

In addition to any modifications explicitly mentioned above, it will be evident to a person skilled in the art that various other modifications of the described examples may be made within the scope of the accompanying claims.

The applicant hereby discloses in isolation each individual feature described herein and any combination of two or more such features, to the extent that such features or combinations are capable of being carried out based on the present specification as a whole in the light of the common general knowledge of a person skilled in the art, irrespective of whether such features or combinations of features solve any problems disclosed herein, and without limitation to the scope of the claims. The applicant indicates that aspects of the present invention may consist of any such individual feature or combination of features.

1. A liquid crystal device comprising at least one liquid crystal cell, the liquid crystal cell having first and second half-cells and liquid crystal material contained between the first and second half-cells, the first and/or second half-cells comprising a first electrode pattern for creating a first radial refractive index pattern in a first region of the liquid crystal material, and a second electrode pattern for creating a second radial refractive index pattern at least partly in the first region of the liquid crystal material, and the liquid crystal device being switchable between activating the first electrode pattern and activating the second electrode pattern.

2. The liquid crystal device according to claim 1, wherein the first half-cell comprises the first electrode pattern and the second half-cell comprises the second electrode pattern.

3. The liquid crystal device according to claim 1, wherein the first and second electrode patterns are centered on a common axis.

4. The liquid crystal device according to claim 1, wherein the first electrode pattern comprises a first set of concentric rings and the second electrode pattern comprises a second set of concentric rings, in which the first electrode pattern comprises a first set of links connecting the first set of concentric rings and the second electrode pattern comprises a second set of links connecting the second set of concentric rings.

5. (canceled)

6. The liquid crystal device according to claim 4, wherein a first link of the first set of links has a larger resistance than a second link of the first set of links radially outward of the first link of the first set of links and a first link of the second set of links has a smaller resistance than a second link of the second set of links radially outward of the third link of the second set of links.

7. The liquid crystal device according to claim 4, wherein the first set of concentric rings corresponds to the second set of concentric rings in at least one of: an area of each ring, a radius of each ring, a depth of each ring, a material of each ring, a spacing between each pair of adjacent rings, or a number of rings, in which the first set of concentric rings is substantially aligned with the second set of concentric rings in a direction parallel to a common axis.

8. (canceled)

9. (canceled)

10. The liquid crystal device according to claim 1, wherein the first electrode pattern comprises a plurality of first concentric sections, wherein each first concentric section comprises a first set of concentric rings and a first set of links connecting the first set of concentric rings; and the second electrode pattern comprises a plurality of second concentric sections, wherein each second concentric section comprises a second set of concentric rings and a second set of links connecting the second set of concentric rings; wherein each first set of links sequentially increase in resistance radially inwards, and each second set of links sequentially decrease in resistance radially inwards, in which the first concentric sections comprise at least one first concentric section having a radially innermost link exhibiting a higher electrical resistance than a radially outermost link of another, radially inwardly adjacent first concentric section; and wherein the second concentric sections comprise at least one second concentric section having a radially innermost link exhibiting a lower electrical resistance than a radially outermost link of another, radially inwardly adjacent second concentric section.

11. (canceled)

12. The liquid crystal device according to claim 1, wherein the first half-cell comprises at least one support film, and the first electrode pattern is located between an innermost support film of the first half-cell and the liquid crystal material; and wherein the second half-cell comprises at least one support film, and the first electrode pattern is located between an innermost support film of the second half-cell and the liquid crystal material.

13. The liquid crystal device according to claim 1, wherein the liquid crystal device is switchable between (i) applying a potential difference across terminals of the first electrode pattern while keeping the terminals of the second electrode pattern at a common potential, and (ii) applying the potential difference across terminals of the second electrode pattern while keeping the terminals of the first electrode pattern at a common potential.

14. The liquid crystal device according to claim 1, operable as an adaptive optical lens.

15. The liquid crystal device according to claim 1, operable as an optical lens switchable between: a positive focal power with the first electrode pattern activated, and a negative focal power with the second electrode pattern activated.

16. An assembly comprising:
a liquid crystal device, the liquid crystal device comprising a liquid crystal cell having first and second half-cells and liquid crystal material contained between the first and second half-cells, the first and/or second half-cells comprising a first electrode pattern for creating a first radial refractive index pattern in a first region of the liquid crystal material, and a second electrode pattern for creating a second radial refractive index pattern at least partly in the first region of the liquid crystal material, the liquid crystal cell being switchable between activating the first electrode pattern and activating the second electrode pattern; and
at least one further optical element.

17. The assembly of claim 16, wherein the at least one further optical element comprises at least one of: a waveguide, a luminance adjustment component, a lens, an image generation device, a reflection-reduction layer, or a protective layer.

18. An apparatus comprising:
a liquid crystal cell comprising first and second half-cells and liquid crystal material contained between the first and second half-cells, the first and/or second half-cells comprising a first electrode pattern for creating a first radial refractive index pattern in a first region of the liquid crystal material, and a second electrode pattern for creating a second radial refractive index pattern at least partly in the first region of the liquid crystal material;
at least one processor; and
at least one storage comprising instructions, the instructions configured to, with the at least one processor, cause the apparatus to switch between:
activation of the first electrode pattern; and
activation of the second electrode pattern.

19. The apparatus according to claim 18, comprising:
at least one electrical connection connected to the first electrode pattern and the second electrode pattern; and
driving circuitry connected to the at least one electrical connection to apply a potential difference between at least part of the first electrode pattern and at least part of the second electrode pattern.

20. The apparatus according to claim 18, comprising at least one sensor to obtain eye tracking data, the instructions configured to, with the at least one processor, cause the apparatus to switch between the activation of the first electrode pattern and the activation of the second electrode pattern at least partly based on the eye tracking data.

21. The apparatus according to claim 20, wherein the apparatus is configured to be mounted on a human head with the liquid crystal cell positioned in a field of view of an eye of the human head, the apparatus further comprising a first lens comprising a first one of the liquid crystal cell; and a second lens comprising a second one of the liquid crystal cell, in which the instructions are configured to, with the at least one processor, cause the apparatus to switch the first lens to a first focal power and the second lens to a second focal power different from the first focal power, in which the first focal power is a positive focal power and the second focal power is a negative focal power, wherein the field of view of the eye is a first field of view of a first eye, and the first lens is configured to be positioned in the first field of view, in use, and the second lens is configured to be positioned in a second field of view of a second eye of the human head, in use.

22. (canceled)

23. (canceled)

24. (canceled)

25. (canceled)

26. The apparatus according to claim 18, wherein the apparatus is at least one of: an augmented reality display device, a virtual reality display device or a mixed reality display device.

27. A method of operating a liquid crystal device comprising at least one liquid crystal cell, the liquid crystal cell comprising first and second half-cells and liquid crystal material contained between the first and second half-cells; the first and/or second half-cells comprising a first electrode pattern for creating a first radial refractive index pattern in a first region of the liquid crystal material, and a second electrode pattern for creating a second radial refractive index pattern at least partly in the first region of the liquid crystal material, the method comprising switching between (i) applying a potential difference across electrical terminals connected to the first electrode pattern and (ii) applying a potential difference across electric terminals connected to the second electrode pattern.
